(19) United States
(12) Patent Application Publication
(10) Pub. No.: US 2004/0172664 A1
(43) Pub. Date: Sep. 2, 2004

(54) Apparatus and methods to convert a legacy cable TV subscriber tap into an addressable subscriber tap

(76) Inventors: Joseph D. Rocci, Lansdale, PA (US); Michael L. Quelly, Quakertown, PA (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/661,815

(22) Filed: Sep. 15, 2003

Related U.S. Application Data
(60) Provisional application No. 60/410,292, filed on Sep. 13, 2002.

(51) Int. Cl. H04N 7/173; H04N 7/16

(52) U.S. Cl. 725/149; 725/127; 725/119; 725/120

(57) ABSTRACT

The present invention provides an apparatus and methods for converting a legacy cable television subscriber passive tap into an enhanced addressable tap. The apparatus includes an addressable control module, one or more RF switch modules and a probe assembly. Additionally, a set of methods is provided for using the present invention to adapt an existing passive tap to an enhanced addressable tap.

This application claims the benefit of U.S. Provisional Application No. 60/410,292, filed Sep. 13, 2002, which is hereby incorporated herein in its entirety.

### BACKGROUND OF THE INVENTION

1. Field of Invention

The present invention relates to communication transmission networks, and more particularly to cable television transmission networks.

2. Related Art

In a cable television transmission network, radio frequency signals are transmitted bi-directionally between a plurality of subscriber premises and a central headend facility.

The bidirectional capability is achieved using a frequency division multiplexing method wherein signals higher than approximately 50 MHz propagate toward subscriber homes and signals lower than approximately 40 MHz propagate toward the headend. These transmission networks commonly employ a hybrid fiber-coax (HFC) architecture, with fiber optic cables used for long distance “trunks,” and coaxial cable employed for the “feeders” that run through the neighborhoods served by the network. The coaxial cables also carry a low frequency AC voltage that powers the active network elements that are installed in the coaxial distribution network.

At various points along the coaxial feeder network where a subscriber attachment is required, a device called a “multi-tap” (or simply “tap”), is installed. The multi-tap contains a specialized circuit that taps off a small percentage of the radio frequency (RF) energy in the feeder for distribution to a small number (typically 2 to 8) of individual subscriber “drop cables,” while allowing most of the RF energy, as well as the network power, to pass through for further distribution. Network power is not commonly allowed to pass down the subscriber drop cable.

A tap and feeder cable contains a number of features that are related to the present invention. FIG. 1 illustrates passive cable television subscriber tap 100, which is representative of a typical passive cable television subscriber tap with a feeder cable connection. Passive cable television subscriber tap 100 (also referred to as passive tap 100) includes tap body 105, seizure screw 110, port plug 115, “F” drop fittings 120, and feeder connectors 125 and 130. FIG. 1 also illustrates hardline coaxial cable 135 (also referred to as a feeder cable) being coupled to passive cable television subscriber tap 100. Hardline coaxial cable 135 includes hardline connector 140 and stinger 145.

As illustrated in FIG. 1, feeder hardline coaxial cable 135 is mechanically and electrically connected to passive tap 100 using special hardline connectors 140 that are secured to the hardline by means of a compression mechanism, and to tap body 105 via screw threads. The hardline center conductor is allowed to extend past the end of the connector to form stinger 145 that is mechanically and electrically connected to the tap's internal circuitry via the clamping action of a seizure screw that is accessible via a port in the tap body. Seizure screw 110 is accessed by temporarily removing threaded port plug 115 that seals the port opening from the external environment. Seizure screw 110, by virtue of its intimate contact with stinger 145, is commonly used as a test point to measure network RF and power levels. Individual subscriber premises drop cables are connected to passive tap 100 via a plurality of threaded F-type drop fittings 120 on tap body 105.

The subscriber multi-tap described above is commonly called a passive tap, because it contains no means to alter or control the flow of signals through it. If a network operator desires to initiate or terminate network service to a subscriber premises, the operator must dispatch service personnel to the tap location and physically connect or disconnect the subscriber drop from the tap. The cost of dispatching service personnel to a subscriber premises to connect, disconnect, or test the service connection—commonly referred to as a truck roll—is a major cost factor for many network operators. Dispatching service personnel is especially troublesome in network areas that serve transient populations because of the frequent need to dispatch personnel. Additionally, the use of passive taps at subscriber premises located in high crime areas creates the undesirable situation in which a network operator must dispatch personnel into an area where they may be subject to personal harm—particularly if they are disconnecting service.

Addressable taps address many of the shortcomings of passive taps, but suffer their own deficiencies. Addressable taps are conceptually identical to passive taps, with the additional capability to remotely control the subscriber connect/disconnect function. In an addressable tap, electronic RF switches in each of the subscriber drop signal paths are controlled via commands transmitted over the cable network. In addition to the circuitry required for normal tap functionality, an addressable tap also requires a data communications transceiver, a microcontroller, a plurality of electronic switches, and a power supply that powers the additional circuits from the network. Consequently, addressable taps suffer from the following drawbacks that often prohibit their widespread use:

Intrusive Installation—Most addressable taps require removal of the entire tap body and replacement with a whole new unit that is usually bigger, requiring cable trimming and network service interruption.

Excessive Power Consumption—The combined power consumption of dozens of addressable taps is often significant, requiring modification to the network powering system.

RF Performance Degradation—Addressable taps commonly have degraded broadband signal passing performance compared to the simpler passive taps that they replace. When several of these units are installed in a single network segment, the RF performance of the whole network segment can be degraded to such an extent that re-alignment of the network segment becomes necessary.

Irreversible Installation—Once the feeder cables and network alignment have been modified to accommodate an addressable tap, it is very difficult to uninstall the addressable tap and revert to the original passive tap.

Cost—Addressable taps contain all of the overhead functions (new housing, passive circuitry, power supply, microcontroller, data transceiver, etc.) required to manage N subscribers, even though only one subscriber home might be served from that tap. For this reason, the cost-per-home does not scale very well in low-density communities.

### SUMMARY OF THE INVENTION

The present invention overcomes each of the above-identified shortcomings and has additional advantages as described herein.

The present invention provides an apparatus and method for converting a legacy cable TV subscriber passive tap into an enhanced addressable tap, while overcoming the above-identified shortcomings. The apparatus includes an addressable control module, RF switch modules and a probe assembly. Additionally, a set of methods is provided for using the present invention apparatus to adapt an existing passive tap to an enhanced addressable tap.

### BRIEF DESCRIPTION OF THE FIGURES

FIG. 1 is a diagram of a passive tap typical of taps used in existing cable distribution networks.

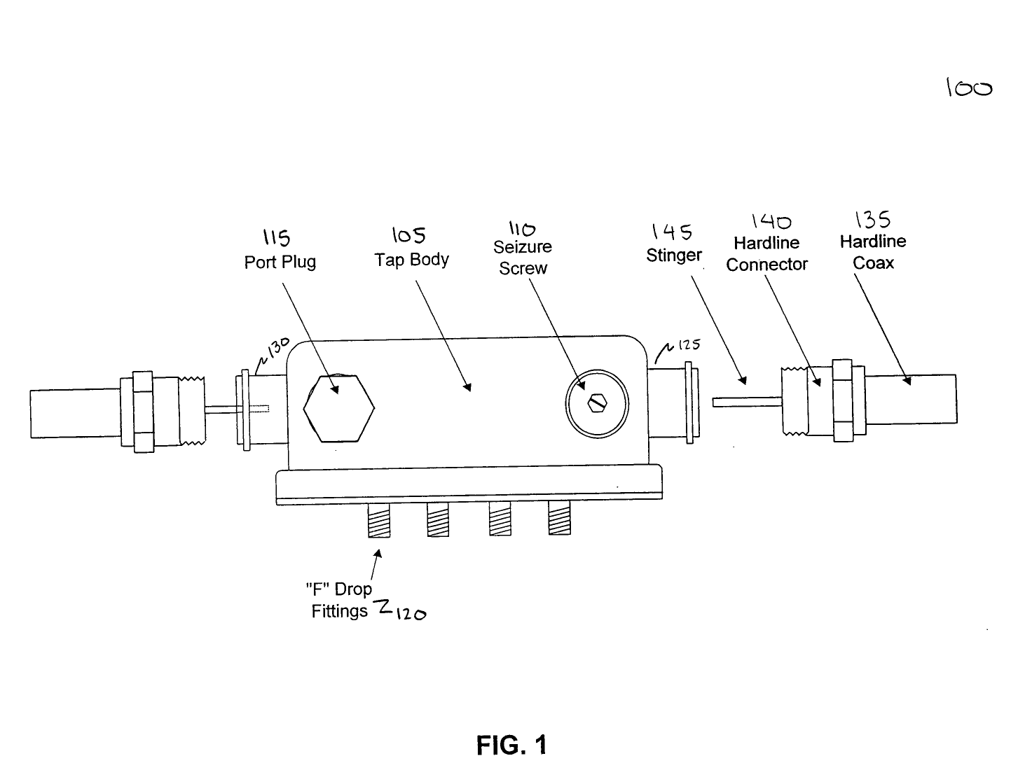

FIG. 2 is a diagram illustrating an addressable control module attached to a passive tap, according to an embodiment of the present invention.

FIG. 3 is a diagram illustrating RF switch modules connected to an addressable control module attached to a passive tap, according to an embodiment of the present invention.

FIG. 4 is a diagram of a probe assembly, according to an embodiment of the present invention.

FIG. 5 is a diagram of a RF switch module control circuit used for powering an RF switch module and to provide two-way control information for an enhanced addressable tap, according to an embodiment of the present invention.

FIG. 6 is a diagram of a RF switch module control circuit used for providing independent control of N RF switches per RF switch model, according to an embodiment of the present invention.

FIG. 7 is a diagram of a RF switch module control circuit used for supervising the presence of drop cables to detect tampering, according to an embodiment of the present invention.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the present invention would be of significant utility.

The present invention overcomes all of the above shortcomings by providing apparatus and associated methods that may be used to adapt original passive tap equipment to make it addressable and more readily managed. The principal components of the apparatus an addressable control module, RF switch modules and a probe assembly.

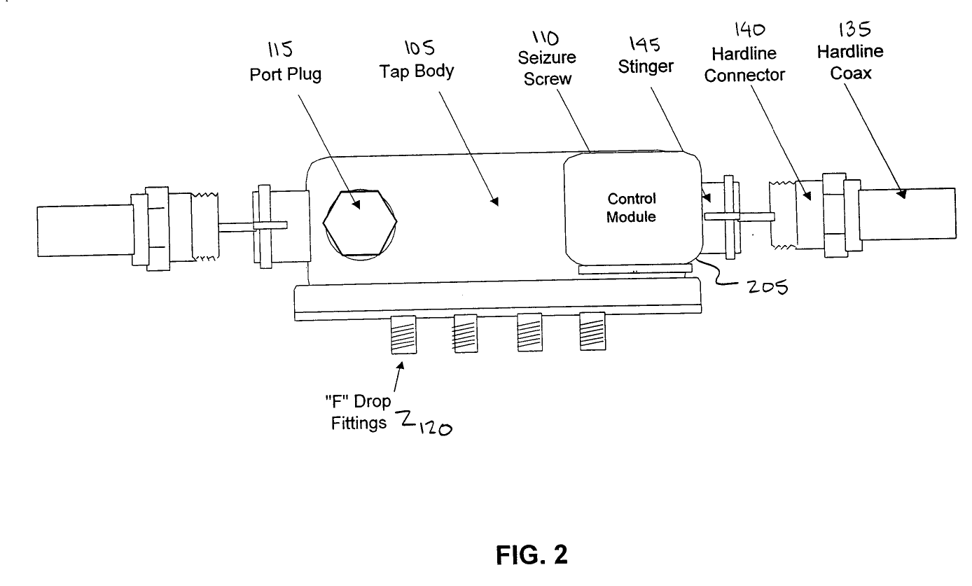

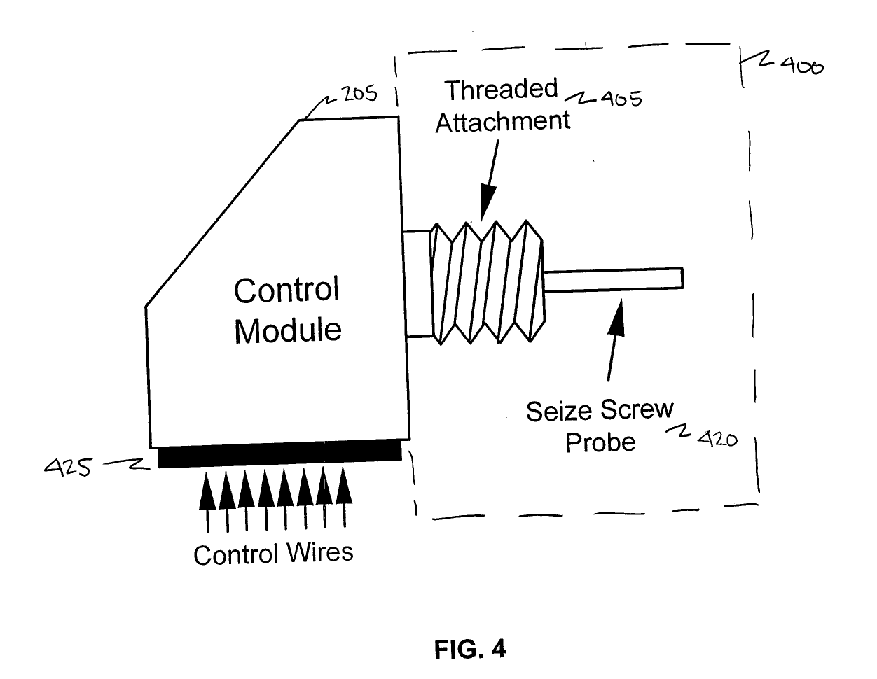

FIG. 2 illustrates an addressable control module 205 attached to passive tap 100, according to an embodiment of the present invention. Addressable control module 205 has a mechanical attachment discussed with respect to FIG. 4 that threads into the seizure screw access port, and an electrical probe that contacts the seizure screw to gain access to a small amount of network power and RF signal. A novel power supply consumes a barely measurable amount of network power and converts it to the appropriate voltages to operate the circuits inside the module. Addressable control module 205 includes a low power RF transceiver and a single chip microcontroller to receive and acknowledge commands sent over the network from a central control system. Addressable control module 205 also has weather-sealed connection points on a control interface for the control wires that drive each of the RF switch modules that are installed.

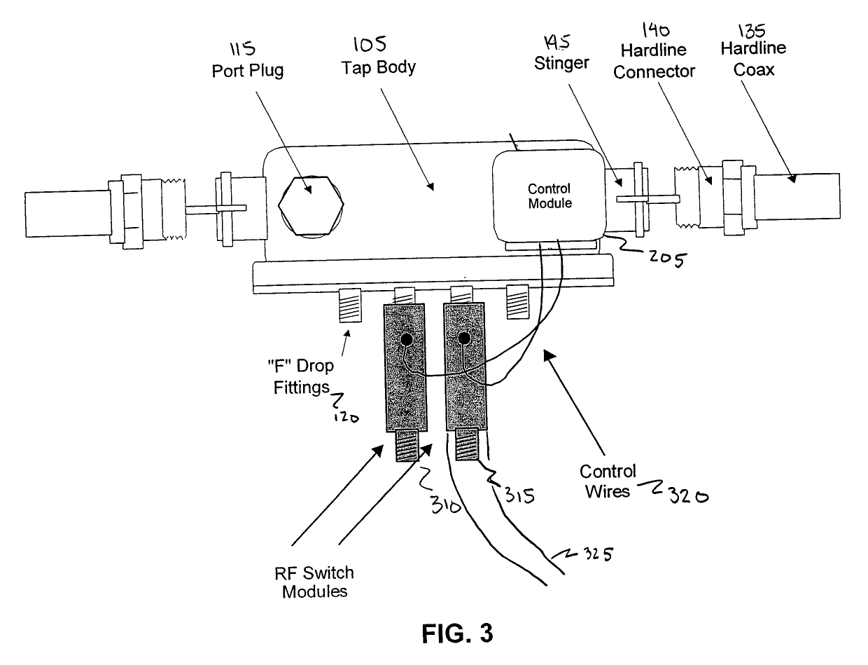

FIG. 3 illustrates example RF switch modules connected to addressable control module 205 attached to passive tap 100, according to an embodiment of the present invention. FIG. 3 shows two RF switch modules 310 and 315 with control wires 320 coupling RF switch modules 310 and 315 to addressable control module 205. The RF switch modules 310 and 315 are tubular assemblies with male “F” fitting threads on one end and female “F” fitting threads on the other end. An RF switch module assembly, such as RF switch modules 310 and 315, is mounted on each tap drop fitting 120 that corresponds to a home that requires addressable control. The home's drop cable is connected to the fitting on the other end of the module, as is provided by the example drop cable 325. An RF switch module, such as RF switch module 310 and 315, has a single control wire that supplies operating power and control signals from the addressable control module.

FIG. 4 illustrates probe assembly 400, according to an embodiment of the present invention. Probe assembly 400 includes threaded attachment 405 and seize screw probe 420. Spring loaded seizure screw attachment 400 in addressable control module 205 contacts tap seizure screw 110 in passive tap 100 when addressable control module 205 is attached in place of one of the tap port plugs, such as port plug 115. Seize screw probe 420 comprises a resistive element that very lightly loads the network RF and power signals so as not to disrupt overall network performance. Seize screw probe 420 provides the addressable control module with very small RF and power signals required to operate the add-on addressable components. FIG. 4 also illustrates control wire interface 425 on control module 205 which is used to connect control wires between control module 205 and RF switch modules, such as RF switch modules 310 and 315. In one embodiment, probe assembly 400 and control module 205 comprise a single assembly. In an alternative embodiment (not pictured), probe assembly 400 and control module 205 are electrically coupled together by a cable. In this case, a bracket can be used to mount control module 205 to a tap body.

A set of methods enables the use of the present invention apparatus to convert an existing passive tap, such as passive tap 100, into an enhanced addressable tap. Additionally, methods are provided that provide additional control and management to an enhanced addressable tap using the apparatus disclosed herein.

A Method of Adapting an Existing Tap for Addressable Control

This method comprises attaching an addressable control module, such as addressable control module 205, and a plurality of RF switch modules, such as RF switch modules 310 and 315 to an existing passive tap, such as passive tap 100 in order to provide remotely addressable control of individual subscriber service.

A Method of Probing the Tap Seizure Screw to Provide Access to Network Power and Signals

This method comprises affixing an addressable control module, such as addressable control module 205, to an existing passive tap, such as passive tap 100, using probe assembly 400. Probe assembly 400 contacts a tap seizure screw, such as tap seizure screw 110 when addressable control module 205 is attached in place of one of the tap port plugs, such as port plug 115. Probe assembly 400 further comprises a resistive probe element that upon contact very lightly loads the network RF and power signals so as not to disrupt overall network performance. The resistive probe element provides addressable control module 205 with the very small RF and power signals required to operate the add-on addressable components.

A Method of Registering Taps and Ordering the Data Communications Transmissions

When a new tap, such as passive cable television subscriber tap 100 including addressable control module 205, is installed in the network, it begins a registration process to identify itself to the remote control system. In this mode, the tap wakes up at intervals that are pseudo random and more frequent than normal intervals, sends a brief message announcing its presence, waits a pre-defined time for a response, and goes back to sleep. If no response to its message is received, the tap wakes up again at the next random interval and tries again. When the tap receives a response to its registration request, it is also told how long to wait before it wakes up to transmit again. This process allows the remote control system to establish the order for tap wake-up times in an optimal fashion that prevents data collisions.

A Method of Minimizing Average Power Consumption by Utilizing a Stored Charge Capacitor

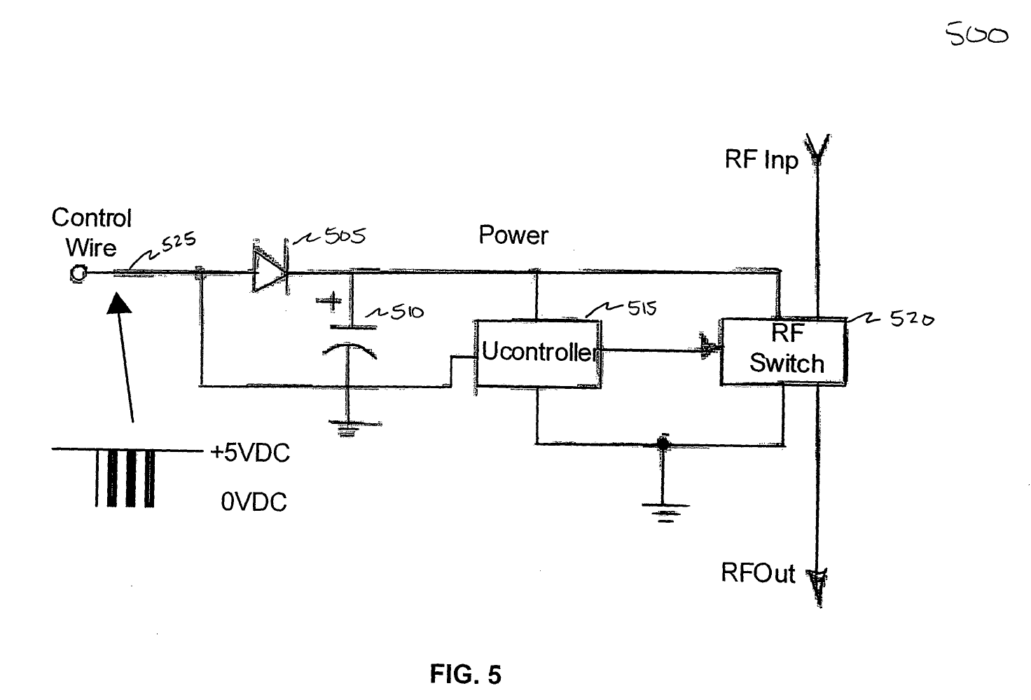

This method comprises a rectifier circuit, such as circuit 500 discussed below with respect to FIG. 5, that charges a capacitor up to a peak voltage derived from the network power waveform. The rectifier current is drawn through the resistive element in the above-mentioned probe in order to minimize the peak current drawn from the network. The active circuitry in an addressable control module, such as addressable control module 205, is only activated for very small time periods at relatively large intervals, thereby allowing the capacitor to recharge slowly between pseudo-random discharge repetition intervals.

A Method of Minimizing Peak Power Consumption by Ordering the Activation Times of the Taps

If every addressable control module, such as addressable control module 205, in every tap in a network segment were activated at the same instant, the combined instantaneous current draw might produce unpredictable effects on network operation. To prevent this condition, each tap is assigned a time slot in which the addressable control module will activate, establish communications with the remote control station, receive its authorization update information, and then go back into a low-power sleep mode. Every time a unit is updated, it also receives information telling it when to wake up again for the next update. Utilizing this method, the remote control station has complete control over the sleep and wakeup times for each tap unit.

A Method of Providing 2-Way Control Information and Powering for the Switch Modules Using a Single Wire Per Switch

An addressable control module, such as addressable control module 205, has connection points for each of the N RF switch modules, such as RF switch modules 310 and 315 that it controls. Each RF switch module has a single control wire that attaches to one of these connection points. An addressable control module uses a special 2-way communications protocol to send control information via a control signal to each RF switch module. This protocol is designed to toggle between two voltage states having values 0 volts and Vcc volts (the power supply voltage). The protocol is further designed so that the control line idles in the Vcc state, and only transitions to 0 volts for very short bit intervals during the relatively short data transmissions to the RF switch module. An RF switch module has a voltage rectifier circuit that charges a capacitor up to the Vcc idle voltage, providing the power supply voltage for the RF switch module circuits. When the addressable control module sends a command to the RF switch module, the command might solicit a response. In this case, the RF switch module will send the response data back to the addressable control module over the same single control wire. FIG. 5 illustrates control circuit 500 located in an RF switch module, such as RF switch module 310 or 315, to support this method, according to an embodiment of the invention. RF Switch Module Control circuit 500 includes voltage rectifier 505, capacitor 510, microcontroller 515, and RF switch 520. Voltage rectifier 505 is used to amplify power signals received from an addressable control module to power microcontroller 515 and RF switch 520. Voltage rectifier 505 as an input coupled to control signal 525. An output of voltage rectifier 505 is coupled to one connection of capacitor 510, microcontroller 515 and RF switch 520.

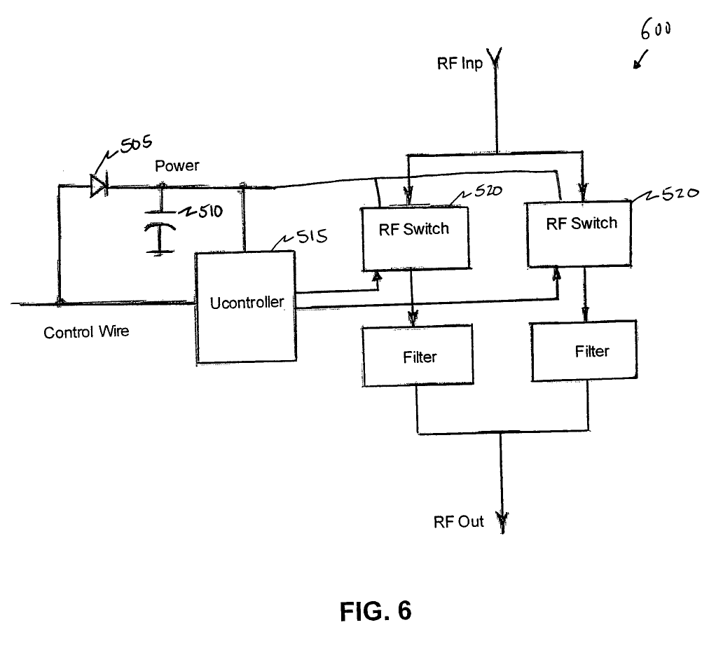

Capacitor 510 is coupled between ground and an output of voltage rectifier 505. Microcontroller 515 is used for controlling and monitoring RF switch 520. Microcontroller 515 has a control input coupled to control signal 520, and a power input coupled to an output of voltage rectifier 505. Additionally, microcontroller 515 has one or more inputs coupled to corresponding RF switches, such as RF switch module 520, for receiving monitoring information related to a subscriber drop cable, and outputs coupled to one or more RF switch modules , such as RF switch modules 310 or 315, for controlling the operation of the RF switch modules. Control circuit 500 can include one or more RF switches, such as RF switch 520. FIG. 6, discussed below, illustrates a case where multiple RF switches are used.

A Method of Providing Independent Control of N Switches Per Switch Module

The power derived from an addressable control module, such as addressable control module 205, via a self-powering protocol provides the capability to employ a low power programmable microcontroller, such as microcontroller 515 inside each RF switch module, such as RF switch module 310 or 315. This microcontroller can decode a plurality of commands sent from the addressable control module over a control wire in order to selectively activate N RF switches inside each RF switch module. Control of multiple RF switches allows the functionality of the RF switch modules to be extended to provide independent On/Off control of a plurality of RF frequency bands. FIG. 6 illustrates circuitry 600 supporting this method.

A Method of Supervising the Presence of Drop Cables to Detect Tampering

An addressable tap can be easily defeated, by removing the subscriber drop cable from the controlled tap output and moving it to an uncontrolled tap output. Alternatively, a drop can be disconnected from its controlled source and tied into a drop that is legitimately active. In either case, attempting to defeat the control of the addressable tap involves removing the drop cable from the port it is supposed to be connected to before it can be reconnected to another signal source. In this method, any attempt to remove the drop cable from the controlling RF switch module, such as RF switch module 310 or 315, will be electronically detected and the addressable control module will signal the remote control system that this has happened.

Removal of the drop cable is determined by exploiting known properties of properly installed drop cables and sensing when these conditions are not met. In a properly installed drop, the low frequency impedance looking into the end of the drop connected to the tap will be either a low DC resistance or a capacitor equivalent to the length of the coaxial drop cable. In either of these valid use cases, if a low frequency square wave is fed to the subscriber tap port via a known high value resistance, the waveform on the drop end of the resistor will vary according to the drop's termination.

If the drop is terminated in a low DC resistance, the waveform at the drop end of the sense resistor will have a very low voltage level.

If the drop is a low frequency open circuit, then it will appear as a capacitor with a value dependent on the length of the cable. In this case, the waveform at the drop end of the sense resistor will not be square anymore, but will have an inverse exponential rise time that is a function of the RC time constant of the sense resistor and the cable capacitance. If the value of the sense resistor is chosen properly, the voltage waveform at the drop end of the sense resistor will be substantially attenuated for normal drop lengths.

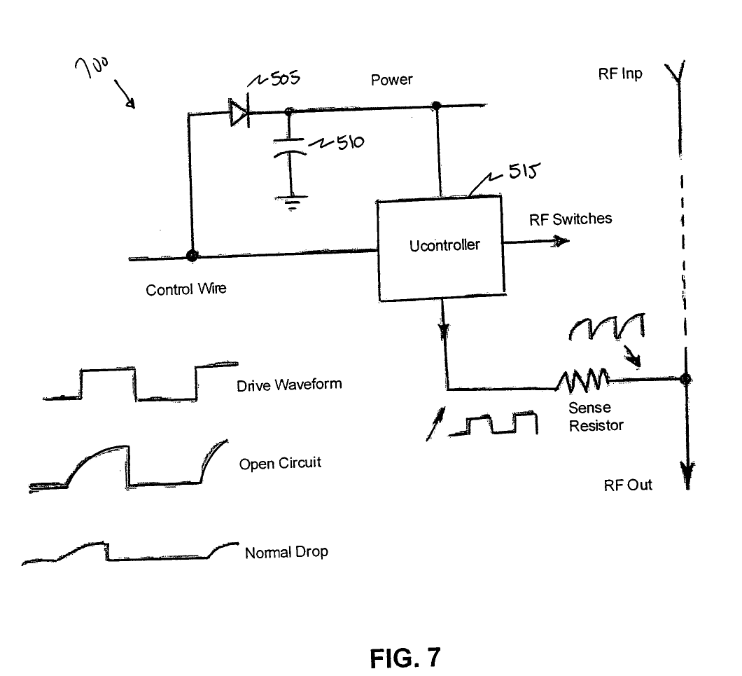

In either case of valid drop termination, the voltage waveform at the drop end of the sense resistor will be low for a properly connected drop cable, and will reach the full peak value of the sense square wave if the drop is disconnected. FIG. 7 illustrates the waveforms referred to above, and circuitry 700 supporting the implementation of the above method.

A Method of Supervising the Presence of RF Switch Modules to Detect Tampering

Another potential way to tamper with service, and potentially obtain service illegally, would be to remove an RF switch module, such as RF switch module 310 or 315, or its control wire. To address this possibility, in this method, an addressable control module, such as addressable control module 205, periodically ‘polls’ a microcontroller, such as microcontroller 515 in an RF switch module, and microcontroller 515 responds to each poll. If an attempt is made to remove the RF switch module or its control wire, this will prevent the expected reply to the poll message and the addressable control module will send a message to the remote control station to notify it that tampering has occurred.

Exemplary embodiments of the present invention are described above. The present invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the present invention.

Conclusion

While various embodiments of the present invention have been described above, it should be understood that they have been presented by way of example, and not limitation. It will be apparent to persons skilled in the relevant art that various changes in form and detail can be made therein without departing from the spirit and scope of the invention.

What is claimed is:

1. A cable television subscriber tap conversion system for converting a passive cable television subscriber tap to an addressable subscriber tap, comprising:
an addressable control module for coupling to the passive cable television subscriber tap;
a RF switch module for coupling to a subscriber drop fitting located on the passive cable television subscriber tap and coupled to said control module; and
a probe assembly for coupling said addressable control module to the passive cable television subscriber tap.

2. The cable television subscriber tap conversion system of claim 1, wherein said addressable control module comprises a control wire interface for coupling one or more control wires to corresponding RF switch modules.

3. The cable television subscriber tap conversion system of claim 1, wherein said RF switch module comprises a control circuit having:
an RF switch coupled to a subscriber drop cable;
a voltage rectifier for providing power to said RF switch having an input coupled to a control signal and an output coupled to said RF switch;
a capacitor coupled between a ground signal and an output of said voltage rectifier;
a microcontroller for controlling and monitoring said RF switch having a control input coupled to the control signal, a power input coupled to an output of voltage rectifier, an input coupled to said RF switch for receiving monitoring information related to the subscriber drop cable and an output coupled to said RF switch for controlling the operation of said RF switch.

4. The cable television subscriber tap conversion system of claim 1, wherein said RF switch module comprises a control circuit having:
a plurality of RF switches coupled to a subscriber drop line;
a voltage rectifier for providing power to each RF switch within said plurality of RF switches having an input coupled to a control signal and outputs coupled to each RF switch within said plurality of RF switches;
a capacitor coupled between a ground signal and an output of said voltage rectifier;
a microcontroller for controlling and monitoring each RF switch within said plurality of RF switches having a control input coupled to the control signal, a power input coupled to an output of said voltage rectifier, an input coupled to each said RF switch for receiving monitoring information related to the subscriber drop cable and an output coupled to each said RF switch for controlling the operation of each said RF switch.

5. The cable television subscriber tap conversion system of claim 4, wherein said plurality of RF switches monitor a plurality of RF frequency bands within the subscriber drop line and support independent on/off control of each RF frequency band with the plurality of RF frequency bands.

6. The cable television subscriber tap conversion system of claim 1, wherein said probe assembly comprises:
a seize screw probe for tapping into a coaxial cable; and
a threaded attachment for affixing said addressable control module to a seizure screw located on the passive cable subscriber tap.

7. The cable television subscriber tap conversion system of claim 6, wherein said seize screw probe taps a tap seizure screw of the passive cable television subscriber tap to provide access to network power and control signals.

8. The cable television subscriber tap conversion system of claim 1, wherein said probe assembly comprises:
a seize screw probe for tapping into a coaxial cable;
a threaded attachment for affixing said probe assembly to a seizure screw located on the passive cable subscriber tap; and
a cable for coupling said probe assembly to said addressable control module.

9. The cable television subscriber tap conversion system of claim 8, wherein said seize screw probe taps a tap seizure screw of the passive cable television subscriber tap to provide access to network power and control signals.
